(19) United States
(12) Patent Application Publication
(10) Pub. No.: US 2008/0023922 A1
(43) Pub. Date: Jan. 31, 2008

(54) Metal gasket

(75) Inventor: Keisuke Umehara, Ayabe-shi (JP)

Correspondence Address: KRATZ, QUINTOS & HANSON, LLP, 1420 K Street, N.W., Suite 400, WASHINGTON, DC, 20005, US

(73) Assignee: KOKUSAN PARTS INDUSTRY CO., LTD., Toyonaka-shi (JP)

(21) Appl. No.: 11/812,113

(22) Filed: Jun. 15, 2007

(30) Foreign Application Priority Data
Jun. 16, 2006 (JP) 2006-167161

(51) Int. Cl. F16J 15/08; F02F 11/00

(52) U.S. Cl. 277/592

(57) ABSTRACT

To provide a metal gasket that can be manufactured at an inexpensive cost and provides sufficient sealing performance around a combustion chamber while preventing a bore bead from fully bending. A metal gasket 1 is constructed from one or more gasket component sheets 10 with an opening 12 formed at a position corresponding to a combustion chamber 6 of an engine, and at least one gasket component sheet 10 has a bore bead 16 formed so as to surround the opening 12. In this metal gasket, a shim sheet 11 for controlling the full bending of the bore bead 16 is fixed to the gasket component sheet 10 in an area between the outer peripheral edge of the bore bead 16 and the inner periphery 7a of a water jacket 7 formed on a cylinder block 2 of the engine.

The present invention relates to metal gaskets that can be suitably used in automobile engines.

### BACKGROUND OF THE INVENTION

1. Field of the Invention

Metal gaskets employed for automobile engines are constructed from one or more gasket component sheets. The gasket component sheet has an opening formed so as to correspond to a combustion chamber, a bore bead formed so as to surround the opening, and a stopper formed around the inner periphery of the bore bead, thereby preventing permanent setting of the bore bead due to its full bending.

2. Description of the Related Art

Stoppers have been proposed and become commonplace in which a peripheral edge of an opening in a gasket component sheet is folded back and the folded portion is utilized as a stopper. Forming the stopper around the inner periphery of the bore bead in this way prevents permanent setting of the bore bead due to its full bending, but a surface pressure on the deck of a cylinder block at an area corresponding to the stopper becomes higher, and the inner side of a cylinder hole deforms in a barrel-like shape, which leads to an increase in oil consumption between the cylinder hole and the piston ring. In today's engines, particularly, a distance between adjacent cylinder holes is minimized, and a distance between the inner peripheral edge of the bore bead and the cylinder hole tends to become narrower for engine miniaturization, and thus the width of the stopper becomes smaller, resulting in the tendency for a surface pressure to be higher in the vicinity of the cylinder hole.

Thus, metal gaskets have been proposed these days in which a stopper is provided around the outer periphery of a bore bead as well as the inner periphery thereof for minimizing the deformation of a cylinder hole. For example, one is described in Japanese Unexamined Patent Publication No. 2002-054743 in which a stopper of coating layer is formed along a bore bead of the gasket component sheet on the inner periphery and outer periphery of the bore bead, and another is described in Japanese Unexamined Patent Publication No. 2005-207536 in which a stopper of waveform in cross section is formed via press-molding along a bore bead of the gasket component sheet on the inner periphery and outer periphery of the bore bead.

Meanwhile, a metal gasket constructed by putting together a plurality of gasket component sheets with bore beads (hereinafter referred to as bead sheet) provides sufficient sealing properties around a combustion chamber, without having to set a tightening torque of a head bolt as high as the bore bead is fully bent, because a large amount of displacement of the bore bead is possible. Accordingly, metal gaskets are also proposed in which a resin layer is formed on a gasket component sheet in the overall area corresponding to a cylinder liner such that the entire cylinder liner receives a surface pressure around the combustion chamber, thereby preventing the deformation of a cylinder hole (for example, see Japanese Unexamined Patent Publication No. 2004-278711).

In addition, metal gaskets are proposed in which a surface pressure adjustment sheet is provided on a gasket component sheet except for an area thereof in which a bore bead is arranged so as to block the deformation of a cylinder hole while preventing the full bending of the bore beads (for example, see Japanese Utility Model Examined Publication No. 2-1469).

In the metal gasket described in Japanese Unexamined Patent Publication No. 2002-054743, since the stopper is formed from a coating layer, it is feared that the coating layer may peel off due to aged deterioration or the like, which decreases sealing performance. Additionally, in the metal gasket described in Japanese Unexamined Patent Publication No. 2005-207536, the stopper is formed via press-molding and causes no peeling problem, but it poses other problems in that forming minute irregularities in the stopper increases a manufacturing cost of a press-molding die and causes the stopper molding portion of the die to be easily broken. These problems place an obstacle in practical use of the metal gasket.

The metal gasket of Japanese Unexamined Patent Publication No. 2004-278711 prevents the deformation of the cylinder hole due to tightening of the head bolt and also ensures sufficient sealing performance. However, it has a critical problem of requiring at least two bead sheets in order to prevent the deterioration of sealing performance involved with cracks in the bore bead caused by the bore bead's full bending, which leads to a high manufacturing cost.

Meanwhile, in the metal gasket of Japanese Utility Model Examined Publication No. 2-1469, since the surface pressure adjustment sheet serves as a stopper for avoiding the bore bead's full bending, it is allowed to provide a larger area of contact with the cylinder liner as compared to the case in which a stopper is provided on the inner periphery of the bore bead, with an advantage of controlling the deformation of the cylinder hole. However, this metal gasket has a problem in that the surface pressure adjustment sheet is also formed in the areas other than the bore bead, that is, it is formed even on the outer edge of the bead sheet, and therefore, a surface pressure on the surface pressure adjustment sheet becomes lower around the combustion chamber than that on the other areas, providing insufficient sealing performance around the combustion chamber. Moreover, the surface pressure adjustment sheet is of the almost same size as the bead sheet, and this eventually requires a manufacturing cost equivalent to that of the metal gasket constructed from two sheets.

An object of the present invention is to provide a metal gasket that can be manufactured at an inexpensive cost and provides sufficient sealing performance around a combustion chamber while preventing the full bending of a bore bead.

### SUMMARY OF THE INVENTION

The inventor carried out a close examination into a metal gasket that suppresses a local increase in surface pressure on a metal gasket around a combustion chamber to avoid the deformation of a cylinder hole and prevents sealing performance from deteriorating due to the full bending of bore bead. Consequently, the inventor has completed the present invention, considering that the arrangement of a shim sheet serving as a stopper around the outer periphery of a bore bead produces a surface pressure to act on a cylinder block at an area distant from a cylinder hole and also allows for a larger area of contact with the cylinder block as compared to the case in which a shim sheet is provided on the inner periphery of the bore bead, and considering that the arrangement of the shim sheet only around the outer periphery of the bore bead, not on the outer edge of the metal gasket, provides a sufficient surface pressure around the combustion chamber, thereby preventing a decrease in sealing performance and also reducing a manufacturing cost of the metal gasket.

A metal gasket related to the present invention is constructed from one or more gasket component sheets with an opening formed at a position corresponding to a combustion chamber of an engine. In the metal gasket in which a bore bead is formed on at least one gasket component sheet so as to surround the opening, a shim sheet for restricting the full bending of the bore bead is fixed to the gasket component sheet in the area between the outer peripheral edge of the bore bead and the inner periphery of a water jacket formed on the cylinder block of the engine.

In this metal gasket, the shim sheet is located on the outer periphery of the bore bead, and thus serves as a stopper for avoiding the bore bead from fully bending, thereby effectively preventing a decrease in sealing performance due to the bore bead's full bending. Additionally, the shim sheet is provided between the outer peripheral edge of the bore bead and the inner periphery of the water jacket, which reduces a manufacturing cost of the shim sheet as compared to the case in which the shim sheet is provided up to the outer edge of the metal gasket, and also allows a higher surface pressure around the combustion chamber than that on the outer peripheral bead to ensure sufficient sealing performance around the combustion chamber. Moreover, the width between the outer peripheral edge of the bore bead and the inner periphery of the water jacket can be larger than the width between the inner peripheral edge of the bore beads and the lip of the opening, which prevents a large local surface pressure from acting around the combustion chamber of the cylinder block and causes a surface pressure to act on the cylinder block at a position distant from the cylinder hole, thereby effectively preventing the cylinder hole from deforming in a barrel-like shape.

In a preferred embodiment, the bore bead is composed of a step bead. The metal gasket is configured to accommodate, by displacement of the bead, variations in a clearance between a cylinder block and a cylinder head caused by the burning of fuel in a combustion chamber, thereby ensuring sealing performance. In addition, known beads include a step bead in which a step is formed on a metal sheet to provide a seal at the upper and lower ends of the step, and a circular bead in which a convex of partial arc in cross section is formed on a metal sheet to provide a seal at the both ends and top portion of the convex. For a bore bead, generally, a circular bead is widely employed, but it must have a large width for a sufficient amount of displacement. Therefore, if the width of the circular bead is to be small for size reduction of an engine, it is necessary to increase a tightening torque of the head bolt so as to decrease variations in a clearance between the cylinder block and the cylinder head, which contributes to the deformation of the cylinder hole. In contrast, the step bead allows a larger amount of displacement with a large step, and also provides a smaller surface pressure than a circular bead does. Thus, employing a step bead as a bore bead, as in the present invention, prevents the deformation of the cylinder hole with a low surface pressure on the cylinder block while ensuring sufficient sealing performance.

For press-molding the step bead, a metal sheet material may be press-molded such that the process height of the step bead becomes three to four times the thickness of the gasket component sheet. In this case, providing a sufficient amount of displacement of the bore bead allows a low surface pressure on the cylinder block to ensure sufficient sealing performance while preventing the deformation of the cylinder hole.

In press-molding the step bead, a metal sheet material may be press-molded such that the process height of the step bead becomes three to four times the thickness of the gasket component sheet, and then the metal sheet material may be flattened such that the process height of the step bead becomes below the sheet thickness of the shim sheet. In this case, since the step bead is flattened such that its process height of three to four times the thickness of the gasket component sheet becomes below the sheet thickness of the shim sheet, the hardness of the step bead is increased via work hardening, thereby effectively preventing the occurrence of cracks in the step bead.

The gasket component sheet may have a plurality of openings, and the shim sheet may be omitted from the area corresponding to an approaching location of adjacent openings. In this configuration, a small-sized engine is achieved with a minimum distance between adjacent cylinder holes.

In another preferred embodiment, the outer edge of the shim sheet is extended up to the range in which a water jacket is formed. In this configuration, it is possible to more effectively prevent an increase in local surface pressure on the metal gasket around a combustion chamber, with a maximum pressure-receiving surface of the cylinder block for receiving the shim sheet.

The cylinder block may be an open deck-type cylinder block, and the outer edge of the shim sheet may be fixed to the gasket component sheet within the area in which the water jacket is formed. Combining the shim sheet and the gasket component sheet is carried out via spot welding, rivetting or mechanical clinching. Preferably, the combining portions are located within the water jacket so that there is no need for forming recesses in the cylinder block or the cylinder head to accommodate the bonding portions.

A coating layer may be formed on the gasket component sheet at an area containing the bore bead. Forming this coating layer preferably further improves sealing performance.

In a preferred embodiment, a thick portion is formed on the shim sheet or a corresponding section of the gasket component sheet so as to be separated from the bolt insertion hole of the head bolt. Since a surface pressure around the combustion chamber between the cylinder block and cylinder head and the metal gasket increases as being closer to the head bolt, the formation of a thick portion at a position distant from the bolt insertion hole through which the head bolt is inserted, allows a uniform surface pressure to be provided all around the combustion chamber, thereby preferably improving sealing performance.

According to a metal gasket related to the present invention, a shim sheet is arranged on the outer periphery of a bore bead and thus serves as a stopper for preventing the bore beads from fully bending, which effectively blocks a deterioration in sealing performance due to the bore bead's full bending. Additionally, the shim sheet is provided only in an area between the outer peripheral edge of the bore bead and the inner periphery of the water jacket, and therefore a manufacturing costs of the shim sheet can be lowered as compared with the case in which a shim sheet is extended up to the outer edge of the metal gasket, and a higher surface pressure can be provided around a combustion chamber than that around the outer peripheral bead, thereby ensuring sufficient sealing performance around the combustion chamber. Furthermore, the distance between the outer peripheral edge of the bore bead and the inner periphery of the water jacket can be larger than the distance between the inner peripheral edge of the bore bead and the lip of the opening, which prevents a large local surface pressure from acting around the combustion chamber of the cylinder block and provides a surface pressure on the cylinder block in an area distant from the cylinder hole, effectively avoiding the cylinder hole from deforming in a barrel-like shape.

### BRIEF DESCRIPTION OF THE DRAWINGS

FIG. 1 is a bottom view of a metal gasket;

FIG. 2 is a vertical cross section view of FIG. 1 taken along line II-II in which the metal gasket is fitted into between a cylinder block and a cylinder head;

FIG. 3 is a vertical cross section view of FIG. 1 taken along line III-III in which an engine with the metal gasket is fitted into between the cylinder block and cylinder head;

FIG. 4 is a vertical cross section view of a metal gasket in the vicinity of a shim sheet;

FIG. 5 is a plan view of a gasket component sheet with no coating layer;

FIGS. 6(a) to (c) are illustrative views of how to form a bore bead;

FIGS. 7(a) to (c) are vertical cross section views of metal gaskets of other constructions in the vicinity of a bore bead;

FIG. 8 is a plan view of a shim sheet of another construction;

FIG. 9 is a plan view of a shim sheet of yet another construction;

FIG. 10 is a cross section view of the same shim sheet taken along line X-X;

FIG. 11 is a bottom view of a metal gasket having a gasket component sheet of another construction with no shim sheet;

FIG. 12 is a cross section view of the same metal gasket taken along line XII-XII;

FIGS. 13(a) to (d) are vertical cross section views of metal gaskets constructed from a plurality of sheets;

FIG. 14 is a vertical cross section view of a metal gasket constructed from a plurality of other sheets that is fitted into between a cylinder block and a cylinder head;

FIG. 15 is a bottom view of a metal gasket into which a shim sheet of another construction is fitted.

EXPLANATION OF SIGNS

| | | | |
|---|---|---|---|
| 1 | metal gasket | 2 | cylinder block |
| 2a | cylinder hole | 3 | cylinder head |
| 4 | connecting surface | 5 | connecting surface |
| 6 | combustion chamber | 7 | water jacket |
| 7a | inner periphery | | |
| 7b | outer periphery | | |
| 10 | gasket component sheet | 11 | shim sheet |
| 12 | opening | 13a | cooling water hole |
| 13b | cooling water hole | 14 | bolt insertion hole |
| 15 | oil hole | 16 | bore bead |
| 17 | bolt hole bead | 18 | bolt oil hole bead |
| 19 | outer peripheral bead | 20 | first coating layer |
| 21 | second coating layer | 22 | opening |
| 23 | fixed portion | 24 | notch |
| 25 | cooling water hole | | |
| 1A | metal gasket | | |
| 10A | gasket component sheet | | |
| 20A | coating layer | | |
| 1B | metal gasket | | |
| 10B | gasket component sheet | | |
| 20B | coating layer | | |
| 1C | metal gasket | | |
| 10C | gasket component sheet | | |
| 20C | coating layer | | |
| 11D | shim sheet | 20D | coating layer |
| 26 | thick portion | | |
| 11E | shim sheet | 26E | thick portion |
| 1F | metal gasket | | |
| 10F | gasket component sheet | | |
| 26F | thick portion | | |
| 1G | metal gasket | | |
| 10G | gasket component sheet | | |
| 1H | metal gasket | | |
| 1J | metal gasket | 30 | sub sheet |
| 1K | metal gasket | | |
| 1L | metal gasket | 11L | shim sheet |
| 1M | metal gasket | 11M | shim sheet |

### DESCRIPTION OF THE PREFERRED EMBODIMENTS

Several embodiments of the present invention will be now described with reference to the drawings.

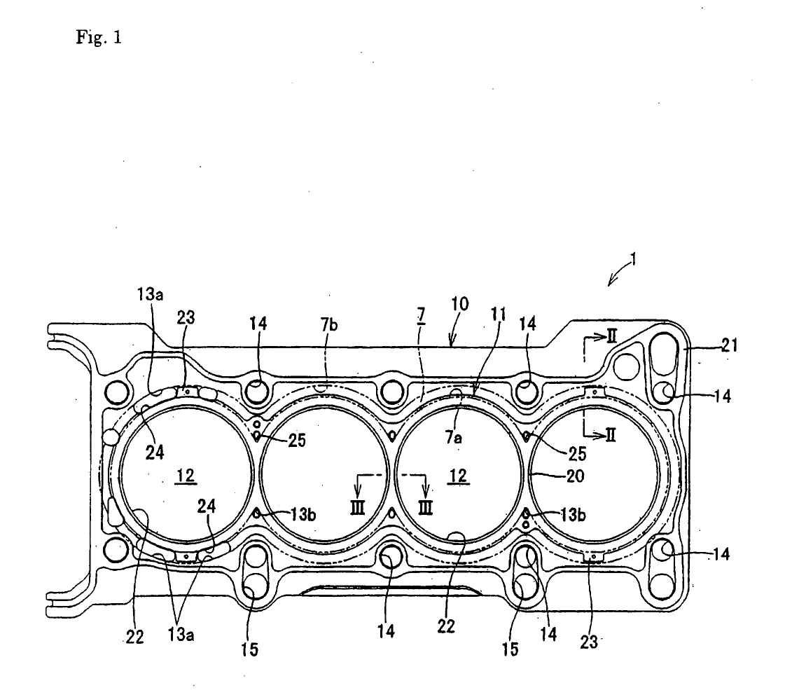

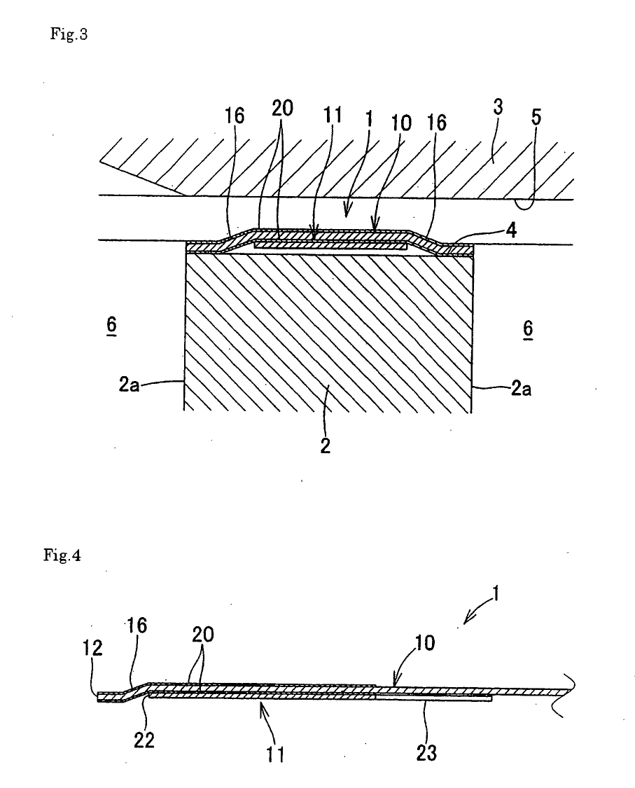

A metal gasket 1 shown in FIGS. 1 to 4 is a metal gasket for multi-cylinder in-line engines. This metal gasket 1 is disposed between connecting surfaces 4, 5 of a cylinder block 2 and cylinder head 3 to seal the both connecting surfaces 4, 5 at a combustion chamber 6, water jacket 7 and lubricant path (not shown). The metal gasket 1 according to the present invention can be used in engines with a cylinder block of cast iron and engines having a cylinder block and a cylinder head based on light alloy such as aluminum alloy and magnesium alloy. In this embodiment, a description is provided as to the case in which the present invention is applied to an engine having the open deck-type cylinder block 2 in which the top side of the water jacket 7 is opened and the cylinder block 2 and cylinder head 3 are formed of aluminum alloy. However, the present invention is also applicable to a cylinder block in which the top side of a water jacket is not opened.

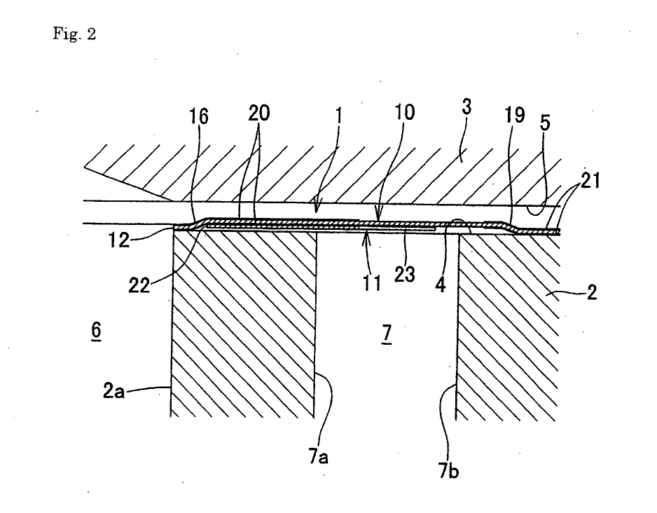

The metal gasket 1 comprises a gasket component sheet 10 disposed across the almost overall connecting surfaces 4, 5 of the cylinder block 2 and cylinder head 3, and a shim sheet 11 laid on the gasket component sheet 10 between the outer peripheral edge of a bore bead 16 and an inner periphery 7a of the water jacket 7 formed in the engine cylinder block 2. The metal gasket 1 shown in FIG. 2 is disposed between the connecting surfaces 4, 5 with the shim sheet 11 on the side of the cylinder block 2, but the metal gasket 1 may be disposed between the connecting surfaces 4, 5 with the shim sheet 11 on the side of the cylinder head 3.

The gasket component sheet 10 is constructed from a stainless steel sheet such as SUS 301 under JIS standards or a well-known metal material having equal characteristics with stainless steel. The outer edge of the gasket component sheet 10 is formed in the almost same shape as the connecting surface 4 of the cylinder block 2. If the gasket component sheet 10 is less than 0.15 mm thick, beads 16 to 19 decrease in stiffness and provide no sufficient surface pressure, and if its thickness exceeds 0.4 mm, the beads 16 to 19 suffer cracks due to deterioration of a processed material or tightening of a head bolt (not shown). Thus, the thickness of the gasket component sheet is to be set between 0.15 and 0.4 mm, preferably between 0.15 and 0.35 mm, and more preferably between 0.2 and 0.25 mm.

A plurality of openings 12 composed of circular holes are spaced out in the longitudinal direction in the almost widthwise central area of the gasket component sheet 10 such that they correspond to the combustion chamber 6. A plurality of cooling water holes 13a are arranged in a predetermined array on the outside of the openings 12 at one side of the sheet such that they correspond to the water jacket 7. Cooling water holes 13b are arranged in the front and rear between adjacent openings 12 such that they correspond to the water jacket 7. A plurality of bolt insertion holes 14 through which head bolts (not shown) are inserted for fixing the cylinder head 3 to the cylinder block 2 are spaced out almost uniformly in correspondence with the outside of the water jacket 7 such that they surround the openings 12, whereby the cylinder head 3 is tightened in a balanced manner with respect to the cylinder block 2. Oil holes 15 through which a lubricant passes are formed on the outside of particular bolt insertion holes 14, such that the lubricant is fed from the cylinder block 2 to the cylinder head 3 for lubrication of a valve operating mechanism and the like.

The gasket component sheet 10 is formed with bore beads 16 surrounding the combustion chamber 6, bolt hole beads 17 surrounding the bolt insertion holes 14, bolt oil hole beads 18 surrounding the bolt insertion holes 14 and the oil holes 15 together, outer peripheral beads 19 surrounding all these pluralities of bolt hole beads 17 and bolt oil hole beads 18, as shown in FIGS. 2 to 5. The outer peripheral beads 19 may not surround the bolt hole beads 17 and bolt oil hole beads 18, provided that they are arranged so as to surround the water jacket 7. The beads 16 to 19 are formed by step beads made from step portions in a metal sheet, but they may be circular beads of partial arc in cross section, or may be any combinations of step beads and circular beads. In the gasket component sheet 10, the shapes, numbers of, and layouts of the openings 12, cooling water holes 13a, 13b, bolt insertion holes 14 and oil holes 15, and the shapes, numbers of, and layouts of the beads 16 to 19, can be set arbitrarily depending on an engine configuration and the like.

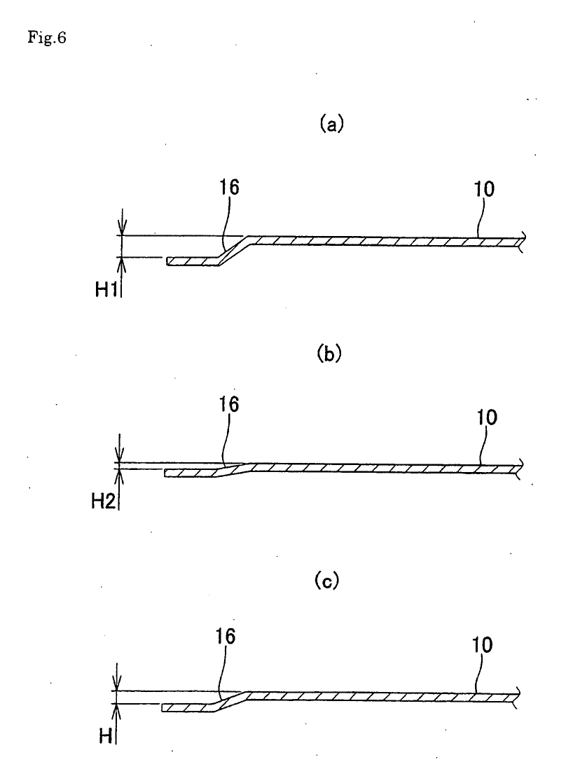

For a step bead constituting the bore bead 16, in press-molding the gasket component sheet 10, a metal sheet material is press-molded such that the process height of the step bead becomes a height H1 of three to four times the thickness of the gasket component sheet 10 as shown in FIG. 6(a), and then the metal sheet material is flattened such that the process height of the step bead becomes a height H2 below the thickness of the shim sheet 11 as shown in FIG. 6(b), whereby the step bead is formed with a height H as shown in FIG. 6(c). As stated above, the step bead is formed with the process height of three to four times the thickness of the gasket component sheet 10 and then the metal sheet material is flattened such that the process height of the step bead becomes below the thickness of the gasket component sheet 10 to form the step bead of the required height H, which enhances the fatigue limit of the step bead due to work hardening and prevents effectively the occurrence of cracks in the step bead. The required height H is set to be, for example, two to four times the thickness of the shim sheet 11 for sufficient sealing performance. However, flattening is not always required and may be omitted. In addition, the beads 17 to 19 may be formed in the same manner as with the bore beads 16.

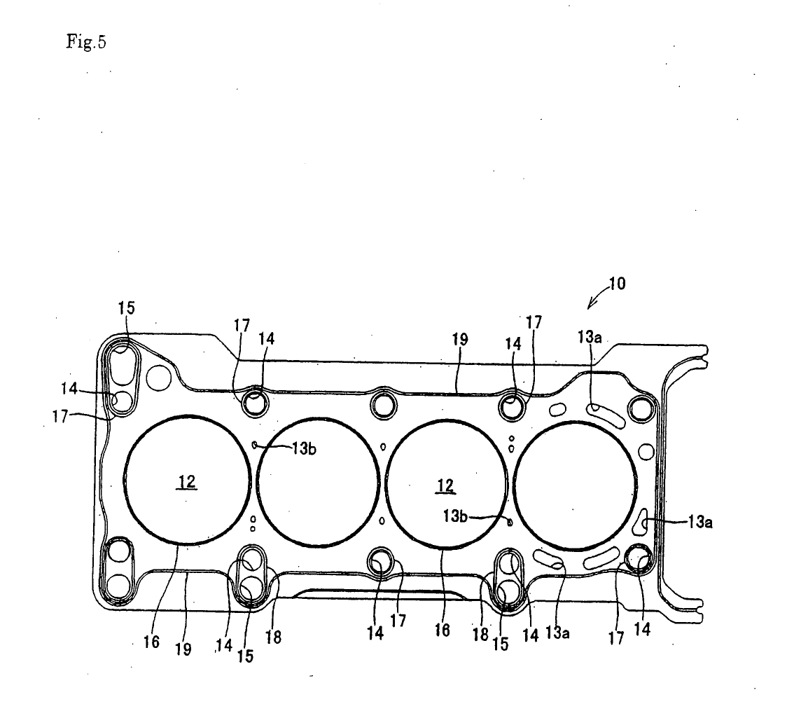

The gasket component sheet 10 may be constructed from a metal sheet alone, and preferably employs a metal sheet in which a rubber coating layer is formed along the beads 16 to 19 on at least one of the upper and lower sides of the gasket component sheet 10 in order to improve sealing properties of the metal gasket 1. More specifically, as shown in FIGS. 1 and 5, the gasket component sheet 10 is provided with a first coating layer 20 covering areas of the gasket component sheet 10 corresponding to the bore bead 16 and the shim sheet 11, and a second coating layer 21 covering the bolt hole bead 17, bolt oil hole bead 18 and outer peripheral bead 19, on the upper and lower sides thereof.

In the same manner with the gasket component sheet 10, the shim sheet 11 is composed of a stainless steel sheet such as SUS301 under the JIS standards or a well-known metal material having equivalent characteristics, and is disposed in a region between the outer peripheral edge of the bore bead 16 and the inner periphery 7a of the water jacket 7 formed in the engine cylinder block 2. However, unlike the gasket component sheet 10, the shim sheet has no beads 16 to 19 formed and may be composed of a metal material available at a more inexpensive cost than the gasket component sheet 10. The thickness of the shim sheet 11 is set between 0.05 and 0.15 mm, preferably between 0.08 and 0.12 mm, and a clearance equivalent to the thickness of shim sheet 11 is provided in the vicinity of the bore bead 16 with a head bolt tightened so that the bore bead 16 is not fully bent.

The shim sheet 11 is formed with four openings 22 that are composed of circular holes of the same diameter as the outer peripheral edge of the bore bead 16, and the edges of these four openings 22 are located along the outer peripheral edge of the bore beads 16. Although the outer edge of the shim sheet 11 is provided up to a location corresponding to the inner periphery 7a of the water jacket 7 for a minimum surface pressure on the cylinder block 2 corresponding to the shim sheet 11, the shim sheet arranged slightly inside the inner periphery 7a of the water jacket 7 falls within the scope of the present invention. In addition, since the molding accuracy of the inner periphery 7a of the water jacket 7 is relatively low, the shim sheet is preferably extended to the location corresponding to the water jacket 7 so that the shim sheet is reliably provided up to the location corresponding to the inner periphery 7a of the water jacket 7. The outer edge of the shim sheet 11 may be extended outside the outer peripheral surface 7b of the water jacket 7, but this leads to a higher manufacturing cost of the shim sheet 11. It is thus preferable to arrange the shim sheet within the region corresponding to the water jacket 7 and near the inner periphery 7a of the water jacket 7.

Fixed portions 23 protruding within the region corresponding to the water jacket 7 are integrally formed in the shim sheet 11 in the front and rear corresponding to the openings 22 on the right and left ends. The shim sheet 11 is fixed to the gasket component sheet 10 via these four fixed portions 23 attached to the gasket component sheet 10 by spot welding, rivetting or mechanical clinching. The shim sheet 11 is formed with a notch 24 and a cooling water hole 25 at positions corresponding to the cooling water holes 13a, 13b in the gasket component sheet 10 such that the shim sheet 11 does not impede the distribution of cooling water.

In an engine fitted with the metal gasket 1 of such a construction, the shim sheet 11 is arranged on the outer peripheral side of the bore bead 16 and thus functions as a stopper for preventing the bore bead 16 from fully bending, which keeps the bore beads 16 from cracking due to the full bending of the bore beads 16 and avoids effectively a decrease in sealing performance that would arise from the occurrence of cracks. Moreover, since the shim sheet 11 is provided only in an area between the outer peripheral edge of the bore bead 16 and the inner periphery 7a of the water jacket 7, a manufacturing cost of the shim sheet 11 can be lowered as compared with the case in which the shim sheet 11 is provided up to the outer edge of the metal gasket 1, and a higher surface pressure can be provided on the bore bead 16 around the combustion chamber 6 than on the beads 17 to 19, thereby ensuring sufficient sealing performance around the combustion chamber 6. Further, since the distance between the outer peripheral edge of the bore bead 16 and the inner periphery 7a of the water jacket 7 can be longer than the distance between the inner peripheral edge of the bore bead 16 and the lip of the opening 12, it is possible to prevent a large local surface pressure from acting on the cylinder block 2 around the combustion chamber 6 and cause a surface pressure to act on the cylinder block 2 in an area distant from the cylinder hole 2a, thereby effectively preventing the deformation of the cylinder hole 2a.

Next, a description will be given as to another embodiment in which the metal gasket 1 is partly modified in construction. The same members as those of the above mentioned embodiment are given the same reference numerals, and they will not be described here in detail.

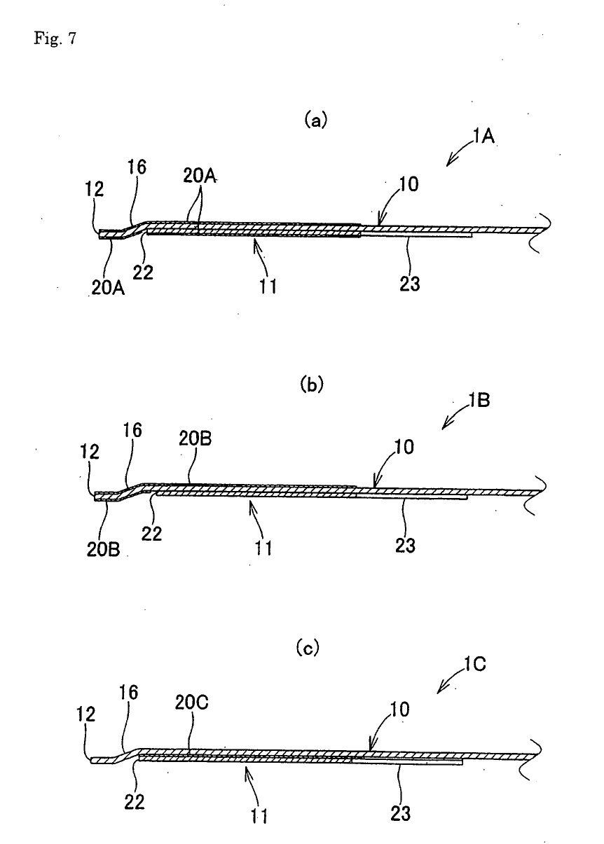

(1) The first coating layer 20 can be formed at any locations. For example, like a first coating layer 20A of a metal gasket 1A shown in FIG. 7(a), the first coating layer may be provided on the upper surface (the cylinder head 3 side) of a gasket component sheet 10A in the area from the lip of the opening 12 of the gasket component sheet 10A to the outer edge of the shim sheet 11, may be provided on the lower surface (the cylinder block 2 side) of the gasket component sheet 10A in the area from the lip of the opening 12 of the gasket component sheet 10A to the inner edge of the shim sheet 11, and may be provided the lower surface of the shim sheet 11 except for the fixed portion 23, and may not be provided in an area between the gasket component sheet 10A and the shim sheet 11.

In addition, like a first coating layer 20B of a metal gasket 1B shown in FIG. 7(b), the first coating layer may be provided on the upper surface (the cylinder head 3 side) of a gasket component sheet 10B in the area from the lip of the opening 12 of the gasket component sheet 10B to the outer edge of the shim sheet 11, may be provided on the lower surface (the cylinder block 2 side) of the gasket component sheet 10B in the area from the lip of the opening 12 of the gasket component sheet 10B to the inner edge of the shim sheet 11, and may not be provided on the lower surface of the shim sheet 11 or between the gasket component sheet 10B and the shim sheet 11. In this configuration, the application of coating layer is minimized in the area corresponding to the shim sheet 11 under a higher surface pressure so that it is possible to prevent a decrease in bolt axis power due to thermal setting and peeling of the coating layer and to prevent effectively a degradation in sealing performance that may arise from the bolt axis power decrease.

Furthermore, like a first coating layer 20C of a metal gasket 1C shown in FIG. 7(c), the first coating layer 20C may be formed on a gasket component sheet 10C or shim sheet 11 such that it is located only between the gasket component sheet 10C and the shim sheet 11.

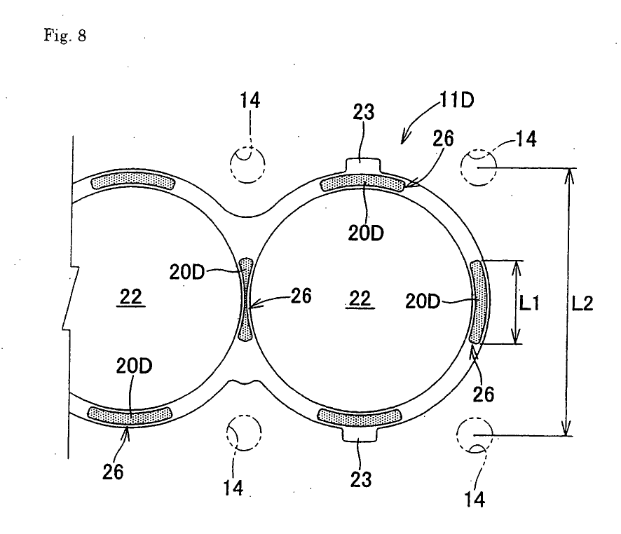

(2) Like a shim sheet 11D shown in FIG. 8, a first coating layer 20D may be formed on at least one of the upper and lower sides of the shim sheet 11D distant from the bolt insertion hole 14. More specifically, since a surface pressure around the combustion chamber 6 becomes lower between the cylinder block 2 and cylinder head 3 and the metal gasket 1 with distance from the head bolt, a thick portion 26 for adding substantial thickness to the shim sheet 11D is formed by the first coating layer 20D at a location distant from the bolt insertion hole 14 through which the head bolt is inserted, that is, at a location between adjacent bolt insertion holes 14. This allows a uniform surface pressure to be applied all around the combustion chamber 6, which leads to a preferable sealing performance increase. The first coating layer 20D is formed, for example, such that a forming range L1 along the tangent in a central area of the first coating layer 20D spans 10 to 40% of a distance L2 between adjacent bolt insertion holes 14. Additionally, instead of forming the first coating layer 20D on the shim sheet 11D, a coating layer may be formed on the gasket component sheet 10 in the area corresponding to the first coating layer 20D so as to provide a uniform surface pressure all around the combustion chamber 6.

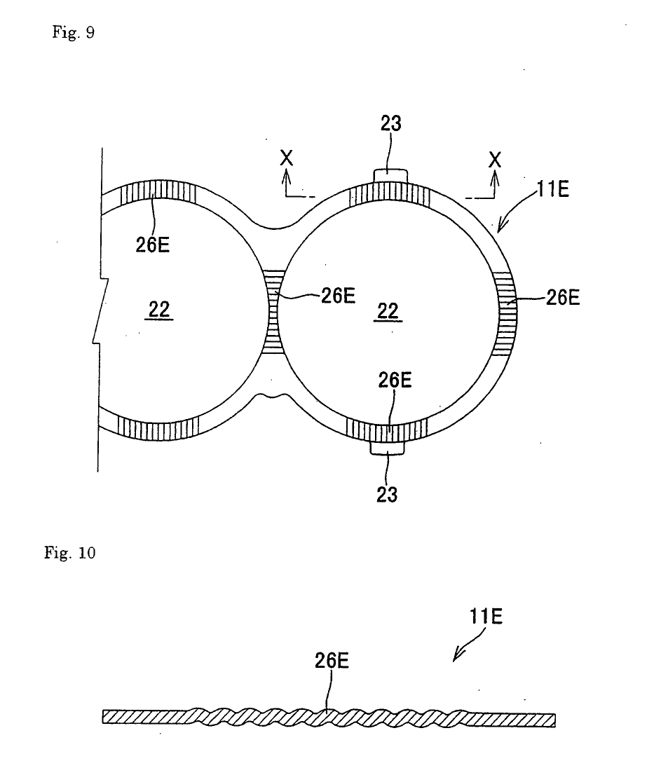

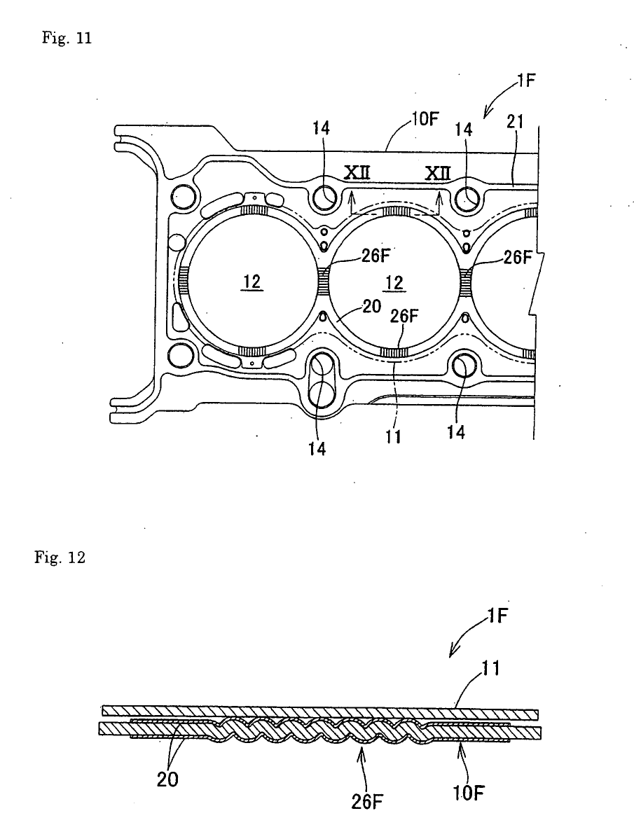

Moreover, like a shim sheet 11E shown in FIGS. 9 and 10, in place of the first coating layer 20D on the shim sheet 11D, a thick portion of waveform in cross section 26E may be provided by applying a pressing process to the shim sheet 11E at the location corresponding to the first coating layer 20D. The cross section of the thick portion 26E may be of sinusoidal waveform, triangular waveform or rectangular waveform. Furthermore, like a metal gasket 1F shown in FIGS. 11 and 12, a thick portion of waveform in cross section 26F may be provided by applying a pressing process to a gasket component sheet 10F at the location corresponding to the thick portion 26.

(3) In the above mentioned embodiments, the metal gasket 1 is constructed from the gasket component sheet 10 and the shim sheet 11, but it may be constructed from a plurality of gasket component sheets 10 and one or more shim sheets 11.

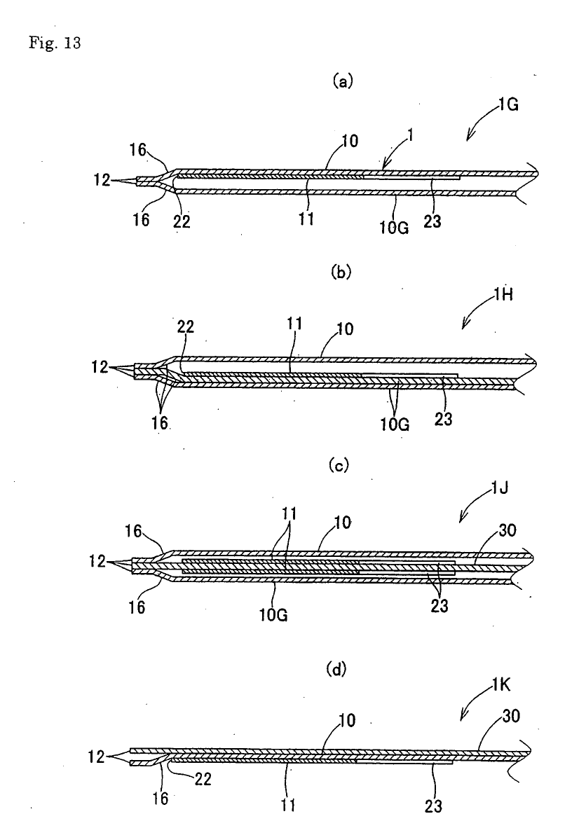

For example, as in a metal gasket 1G shown in FIG. 13(a), it is allowed to lay a gasket component sheet 10G of the same construction as the metal gasket 1 except for reversed steps in the bead 16 to 19, on the lower side of the metal gasket 1. The metal gasket 1G of such a construction provides a seal around the combustion chamber 6 via the two beads 16 and it can be thus used suitably for gasoline injection turbo engines and diesel engines under high combustion pressures.

Additionally, as in a metal gasket 1H shown in FIG. 13(b), it is allowed to put together one gasket component sheet 10 and two gasket component sheets 10G, and fix a shim sheet 11 to the upper side of the upper gasket component sheet 10G. In this metal gasket 1H, the upper gasket component sheet 10G is allowed to serve as a compression ratio adjustment sheet by using a plurality of thicknesses of the gasket component sheet 10G for each 0.05 mm, for example, and it can be thus employed suitably for diesel engines with a gasket of varied thicknesses.

Further, as in a metal gasket 1J shown in FIG. 13(c), it is allowed to provide the gasket component sheet 10, a gasket component sheet 10G, and a flat sub sheet 30 configured in the same manner as the gasket component sheet 10 except that there are no beads 16 to 19, and it is allowed to fix the shim sheet 11 to the upper and lower sides of the sub sheet 30.

Furthermore, as in a metal gasket 1K shown in FIG. 13(d), it is allowed to place an almost flat sub sheet 30 on the upper side of the gasket component sheet 10 of the metal gasket 1. This metal gasket 1K allows the sub sheet 30 to reduce damage to the coating and accommodate adverse effects of a caving in a casting.

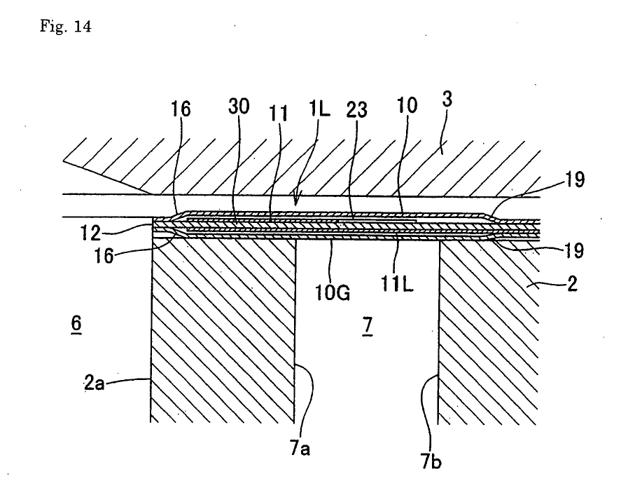

Additionally, as in a metal gasket 1L shown in FIG. 14, in place of the lower shim sheet 11 of the metal gasket 1J, it is allowed to arrange a shim sheet 11L in which an outer edge is extended up to the outer edge of the gasket component sheet 10. Even if a plurality of gasket component sheets 10 are to be used, a coating layer can be formed in the same manner described above.

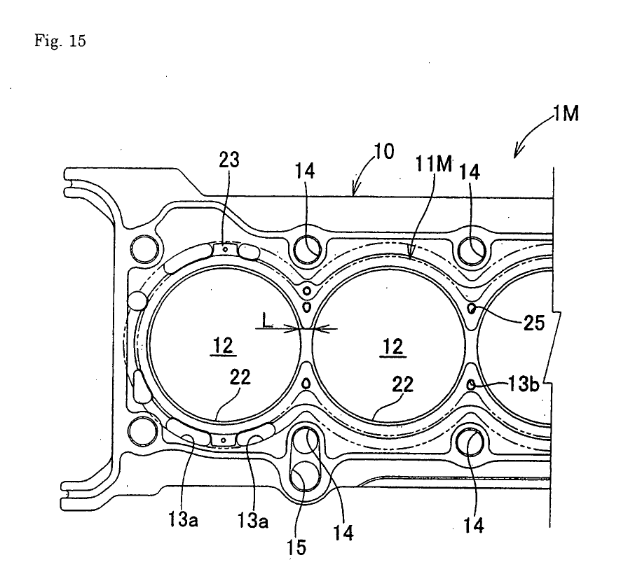

(4) The shim sheet 11 in the above mentioned embodiments is also located between adjacent openings 12. In another preferred embodiment, a shim sheet 11M is omitted in the area between adjacent openings 12, like a metal gasket 1M shown in FIG. 15. In this configuration, the bore beads 16 are allowed to be closer to each other as much as possible between adjacent openings 12, and thus the distance between the cylinder holes 2a can be reduced to a minimum for size reduction of the cylinder block 2. However, it is necessary to provide the shim sheet 11M to the area in which a distance L between adjacent cylinder holes 2a is more than 8 mm in order to curb sufficiently the uplift of the cylinder head between the cylinder holes 2a, and therefore the shim sheet 11M are to be omitted only in the area in which the distance L is 8 mm or less. The shim sheet 11M is also applicable to the above mentioned metal gaskets.

In these embodiments, the present invention is applied to the metal gasket that is attached to the cylinder block 2 and cylinder head 3 of a multi-cylinder in-line engine, and it may also be applied to single-cylinder engines and V-type engines. The present invention is also applicable to air pumps as well as engines.

1. A metal gasket constructed from one or more gasket component sheets with an opening at a position corresponding to a combustion chamber of an engine, and having a bore bead formed in at least one gasket component sheet so as to surround the opening, characterized in that
a shim sheet for controlling the full bending of the bore bead is fixed to said gasket component sheet in an area between an outer peripheral edge of the bore bead and an inner periphery of a water jacket formed in a cylinder block of the engine.

2. The metal gasket according to claim 1, wherein said bore bead is composed of a step bead.

3. The metal gasket according to claim 2, wherein, for press-molding said step bead, a metal gasket material is press-molded such that a process height of the step bead is three to four times the thickness of the gasket component sheet.

4. The metal gasket according to claim 2, wherein, for press-molding said step bead, a metal sheet material is press-molded such that a process height of the step bead is three to four times the thickness of the gasket component sheet, and then the metal sheet material is flattened such that a process height of the step bead is below the thickness of the shim sheet.

5. The metal gasket according to claim 1, wherein said gasket component sheet has a plurality of openings and employs, as said shim sheet, a shim sheet that is omitted in an area corresponding to an approaching location of adjacent openings.

6. The metal gasket according to claim 1, wherein an outer edge of said shim sheet is extended up to within a forming range of a water jacket.

7. The metal gasket according to claim 1, wherein said cylinder block is an open deck-type cylinder block, and an outer edge of said shim sheet is fixed to a gasket component sheet within the forming range of the water jacket.

8. The metal gasket according to claim 1, wherein a coating layer is formed on said gasket component sheet in an area containing a bore bead.

9. The metal gasket according to claim 1, wherein a thick portion is formed on said shim sheet or a corresponding part of the gasket component sheet in a location distant from a bolt insertion hole for a head bolt.
